(19) United States
(12) Patent Application Publication
(10) Pub. No.: US 2019/0230039 A1
(43) Pub. Date: Jul. 25, 2019

(54) METHOD AND SYSTEM FOR EXTRACTING IN-TUNNEL FLOW DATA OVER A VIRTUAL NETWORK

(71) Applicants: ESTINET TECHNOLOGIES INC., Hsincu (TW); National Chiao Tung University, Hsinchu City (TW)

(72) Inventors: SHIE-YUAN WANG, HSINCHU (TW); MIN-YAN LIN, MIAOLI COUNTY (TW)

(21) Appl. No.: 16/052,587

(22) Filed: Aug. 1, 2018

(30) Foreign Application Priority Data
Jan. 19, 2018 (TW) 107102051

(51) Int. Cl. H04L 12/851; H04L 12/931; H04L 12/46; H04L 29/06

(52) U.S. Cl. CPC H04L 47/2483; H04L 49/70; H04L 49/354; H04L 47/2441; H04L 12/4641; H04L 49/201; H04L 69/22; H04L 12/4633

(57) ABSTRACT

The disclosure is related to a method and a system for extracting flow data inside a tunnel over a virtual network. The method is achieved by modifying flow tables operated in a switch. The switch extracts data of the in-tunnel flow when the data is transmitted among computers that run software switches over the virtual network. The switch conducts monitoring, metering and management of the in-tunnel flows. A virtual machine running in a computer generates a packet that is encapsulated through a tunnel protocol at a logical port. The packet is then transmitted to the switch. The switch uses the flow tables to perform packet lookups for extracting the in-tunnel flow after the packet is de-capsulated. The packet is then re-encapsulated and forwarded to a logical port of the switch that connects to a destination computer. The destination computer can acquire the original packet after de-capsulating the packet.

### BACKGROUND OF THE INVENTION

### 1. Field of the Invention

The disclosure is generally related to a method and a system for extracting network flow data, and in particular to a method for extracting in-tunnel flow (i.e., flows inside a tunnel) data among nodes within a virtual network, and a system thereof.

### 2. Description of Related Art

Software-Defined Networks (SDN) is a next generation network architecture that incorporates a centralized controller to act as the control plane of the switches of a conventional distributed network system. The architecture of the software-defined network allows the switches in the network to process the traditional data plane since the control plane is at the controller. The centralized controller provides optimized control for the system.

The centralized architecture of software-defined networks implements topology optimization and renders better routings by the controller. The communication between the controller and switches is made through standard and open protocols such as the OpenFlow protocol. The OpenFlow protocol allows developers to develop widely compatible network devices using public standards rather than their own standards. The standardized architecture allows the network administrator to program or optimize applications of the controller according to practical requirements, so that multi-functional application modules can be provided.

The OpenFlow protocol provides a unified communication interface that allows the control plane and the data plane to be communicated with each other. The control plane utilizes the flow tables inside switches and installs flow entries into these tables to control the data plane for forwarding and looking up packets. The data plane forwards packets according to the installed flow entries as communicated with an SDN controller.

A modern data center usually adopts a Software-Defined Network as its operational architecture that constitutes a virtual network. Multiple virtual machines used to serve clients can be established over the virtual network. The virtual network operates its functions based on a tunnel technology. However, a switch in the virtual network cannot recognize the in-tunnel flows (i.e., the flows inside a tunnel) because the data delivered between the virtual machines is encapsulated inside a tunnel and the encapsulation/decapsulation only occurs at the starting point or the ending point of the tunnel. A drawback of the conventional technology is that an administrator of the network cannot effectively recognize and monitor the in-tunnel flows for the purpose of controlling traffic and optimizing the usage of network bandwidth.

### SUMMARY OF THE INVENTION

In view of the drawback of the conventional technology that in-tunnel traffic flows between switches cannot be monitored, a method and a system for extracting in-tunnel flow data in the virtual network are provided. In the method, the switch is able to identify the data of different in-tunnel flows. The method can be applied to an SDN (software-defined network) switch. The SDN switch supports the OpenFlow protocol and is able to communicate with the SDN controller. A flow bandwidth usage limit scheme such as a metering scheme can be applied to an identified in-tunnel flow.

In one embodiment, the method for extracting in-tunnel flow data in the virtual network can be applied to a switch. In the method, a node operating as a switch, e.g., a software switch, is provided for receiving packets generated by a virtual machine operated in the first host. The packets are encapsulated by a tunnel protocol at a logical port created by the first software switch executed in the first host, and the encapsulated packets are transmitted to the switch via a virtual network tunnel.

After the packets are de-capsulated at an input logical port of a switch, the in-tunnel flow data is extracted and the header of the extracted packets is used to look up the flow tables. After the flow tables are looked up, the statistics of the in-tunnel flow is updated, and the in-tunnel flow is metered for bandwidth management of the in-tunnel flow. After that, the packets are re-encapsulated by the tunnel protocol at an output logical port of the same switch. While the packets are re-encapsulated, the header of the packets is modified by incorporating information relating to the switch and the destination host.

The re-encapsulated packets are transmitted to a logical port created by the second software switch running inside the destination host via a virtual network tunnel. When the logical port of the second software switch receives the re-encapsulated packets, the packets are de-capsulated into the original data.

In one further embodiment, a system for performing the method for extracting in-tunnel flow data in the virtual network is provided. The system includes a plurality of switches and connects with a plurality of hosts via the virtual network. The first host runs the first virtual machine and executes the first software switch. A virtual network tunnel is established between the first host and the switch. The second host runs the second virtual machine and executes the second software switch. Another virtual network tunnel is established between the second host and the switch. The method for extracting in-tunnel flow data is performed by the switch. In the method, the packets generated by the first virtual machine are encapsulated by a tunnel protocol at a logical port of the first software switch. The encapsulated packets are transmitted to the switch via a virtual network tunnel. While the switch de-capsulates the packets, the switch looks up the flow tables according to the header of the extracted packets so as to extract the in-tunnel flow data accordingly. One of the objectives of the process is to meter and update statistics of the in-tunnel flows so as to manage the bandwidth usages of in-tunnel flows.

After accomplishing extraction of the in-tunnel flow data, the packets are re-encapsulated and transmitted to the destination host via another virtual network tunnel. At a logical port created by the second software switch operated in the destination host, the packets are de-capsulated for obtaining the original data in the second virtual machine.

### BRIEF DESCRIPTION OF THE DRAWINGS

FIG. 1 shows a schematic diagram depicting a system and a virtual network that incorporate in-tunnel operation in one embodiment of the present disclosure;

FIG. 2 shows a schematic diagram depicting the system and the virtual network in one further embodiment;

FIG. 3 shows a flow chart describing the steps for transferring the packets in one embodiment of the present disclosure;

FIG. 4 shows a schematic diagram depicting a network system constituted by a plurality of nodes in the virtual network in one embodiment of the present disclosure;

FIG. 5 shows an example of the flow tables operated in a software switch in a network system;

FIG. 6 shows a flow chart describing the method for extracting in-tunnel flow data in the virtual network according to one of the embodiments of the present disclosure;

FIG. 7 shows a schematic diagram depicting a system for performing the method for extracting in-tunnel flow data in the virtual network in one further embodiment of the present disclosure;

FIG. 8 shows an example of the modified flow tables operated in a software switch in the network system; and

FIG. 9 shows one further diagram describing the system for performing the method for extracting in-tunnel flow data in the virtual network in one further embodiment of the disclosure.

### DETAILED DESCRIPTION OF THE PREFERRED EMBODIMENTS

The present invention will now be described more fully with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

A centralized controller, e.g., an SDN controller, used in a Software-Defined Network (SDN) causes a network to obtain an optimized and preferable routing plan. Preferably, the OpenFlow protocol implemented in the SDN allows the controller to conduct a standard and public communication with an SDN switch. The SDN switch utilizes a flow table to control a data plane including actions such as message delivery, forwarding and lookups. The actions form a flow entry. The data plane of the SDN switch conducts determination and execution according to the flow table. This aspect allows a network administrator to program or optimize the applications of the controller for developing a versatile application module.

Modern data centers usually adopt the SDN as an operating architecture. The SDN is separated into a data plane and a control plane. A centralized controller replaces the control plane of the conventional switch of a distributed network system. The SDN allows the SDN switch to only be responsible for the data plane, and the centralized controller can be optimized to satisfy control requirements.

In a data center, a subscriber can create his own virtual network. A virtual machine is configured to connect with this virtual network. The virtual machines can be communicated with each other through this virtual network. The establishment of the virtual network is based on a tunneling technology by encapsulating packets of a network protocol within packets carried by another network. The data transmitted between the virtual machines can be encapsulated or de-capsulated at the starting point or at the ending point of a tunnel. Therefore, an in-tunnel flow (i.e., a flow encapsulated in a tunnel) is not recognizable to a switch in a network, and the data flow in the tunnel cannot be monitored, metered, and controlled. The method for extracting the in-tunnel flow data of a virtual network of the disclosure allows the switch to identify the in-tunnel flows. This method can be applied to an SDN switch that supports the OpenFlow protocol communicating with an SDN controller. The SDN controller therefore is able to apply a rate limit to an identified in-tunnel flow. When measuring the performance of an environment that deploys a cloud-based operating system, e.g., OpenStack, the network bandwidth usage of every in-tunnel flow can be accurately recorded. Furthermore, rather than the conventional measurement being applied to the application layer of the switch, the scheme of performance measurement of the disclosure does not cause an excessive burden on the overall performance of the switch.

The OpenFlow protocol is used as a communication protocol performed among the network switches. The OpenFlow protocol defines three message types such as packet-in, flow-mod and packet-out.

The switch, e.g., an SDN switch, uses the OpenFlow protocol to communicate with a controller, e.g., an SDN controller. The switch utilizes a flow table to conduct actions such as forwarding and lookups based on the installed flow entries. In the initial state, the flow table is preset to be empty, and is configured to request the controller for assistance if no flow entry is matched by an incoming packet.

In an exemplary example, a flow is created on a host and its packets are transmitted from the host to the switch that is connected with a controller. When the switch receives a packet of this flow, it looks up a flow table in its memory. If a matching flow entry in the flow table is found, the switch performs the action of the matched flow entry and updates the statistics of the flow entry. The switch will generate a packet-in message for packaging the received packet into the packet of the packet-in message if no flow entry is matched. The packaged packets, including the flow information, are transmitted to the controller. The controller utilizes its control logic to generate a flow-mod message and transmits the flow-mod message with a packet-out message to the switch. This action makes the switch add a new flow entry carried by the packets of the flow-mod message. The new flow entry allows the subsequent packets of the same flow to be matched without generating any further packet-in messages for requesting further actions from the controller.

Under this flow entry approach, the performance of the switch will not be affected since it is not necessary for a processor of the switch to repeat the process of processing the first packet of a new flow and communicating with the controller.

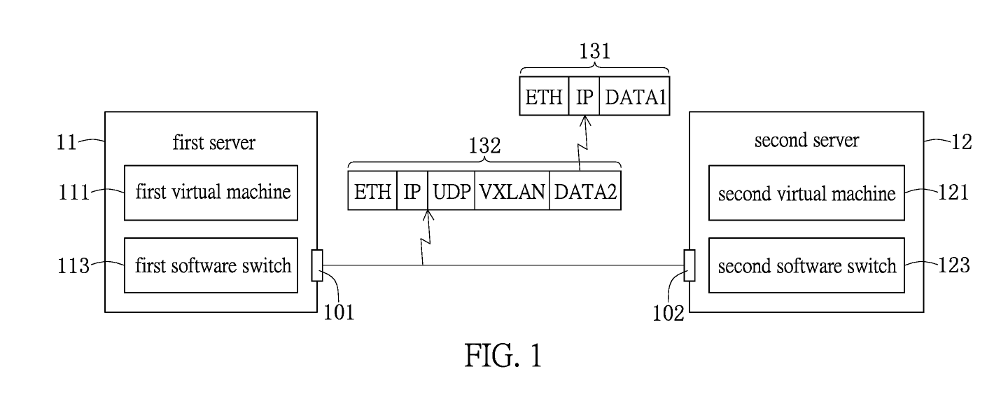

The data center that operates the method and system for extracting in-tunnel flow data of a virtual network adopts a tunneling protocol. The tunneling protocol is such as the VXLAN (Virtual Extensible LAN) protocol that is a network virtualization technology. Another aspect such as GRE (Generic Routing Encapsulation) can also be used in the virtual network. Reference is made to FIG. 1, showing a schematic diagram of a conventional architecture of a virtual network applying a specific tunneling operating mechanism.

In the diagram, both the first server 11 and the second server 12 have the virtual machines (VMs) and software switches that can be implemented by OVS (Open vSwitch) supporting the OpenFlow protocol. The virtual machines running in the servers 11 and 12 are respectively the first virtual machine 111 and the first software switch 113, and the second virtual machine 121 and the second software switch 123. The two servers 11 and 12 uses a tunnel protocol such as VXLAN to establish a tunnel over the virtual network. A first tunnel endpoint 101 with respect to the first server 11 and a second tunnel endpoint 102 with respect to the second server 12 embody the VXLAN Tunnel Endpoints (VTEPs) that are communicated with sockets set for communication and packet forwarding.

A Sampled Flow (sFlow) technology is provided for monitoring the in-tunnel flow (ITF). This sFlow samples the packets with a sampling rate and analyzes the first N bytes of each packet. For example, a default N value may be 128. For avoiding degrading system performance due to too high a sampling rate or causing sampling error due to too low a sampling rate being used, the system needs to sample packets at a suitable sampling rate. The system can also update flow statistics thereof. The data carried by the packet can be separated into two parts including a header and the content. The header of the packet carries control information, for example ETH and IP of the original first packet 131. It is noted that ETH and IP respectively refers to the Ethernet protocol and the IP network protocol, and the content refers to a payload, e.g., DATA 1 of the first packet 131. Once the packet is delivered over the virtual network shown in the figure, a tunnel protocol, e.g., the VXLAN protocol, is used to re-capsulate the first packet so as to form the second packet 132 carrying information such as ETH, IP, UDP, and a header ‘VXLAN.’ The second packet 132 carries the header, including the information that the packet is re-encapsulated by VXLAN, and DATA 2, including the original information encapsulated in the first packet 131, over the virtual network.

While the VXLAN tunnel protocol is in operation, a range with a 24-bit VXLAN tunnel ID, e.g., VNI, TUN ID, is provided. The VXLAN tunnel protocol is able to provide the capability of leasing multiple virtual hosts that allows the cloud service to divide its subscribers thereamong. The servers 11 and 12 run the first virtual machine 111 and the second virtual machine 121 respectively. Each server supports multiple virtual machines. When two virtual machines are required to communicate with each other, a same VNI is utilized. Thus, the virtual network system can distinguish its subscribers by the VNIs. The aspect of VNI in the system allows the subscribers to not affect each other even if they use the same IP address associated with the same physical port. The data transmitted in the system forms the in-tunnel flow (ITF). For example, when an ICMP packet is delivered from the first virtual machine 111 to the second virtual machine 121, the ICMP packet is encapsulated at the first tunnel endpoint 101. An outer header of the packet carries the information relating to both the first tunnel endpoint 101 and the second tunnel endpoint 102. The second packet 132 is then de-capsulated at the second tunnel endpoint 102. A switch existing between the first tunnel endpoint 101 and the second tunnel endpoint 102 is required to learn the MAC (Media Access Control) addresses of both the tunnel endpoints rather than the MAC addresses of the virtual machines.

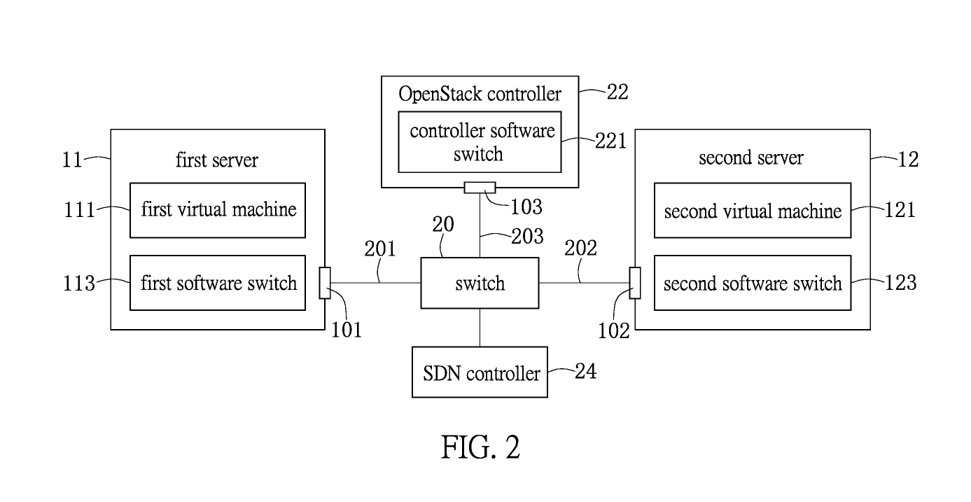

For extracting the in-tunnel flow data over the virtual network, a switch 20 is disposed between the first server 11 and the second server 12. Reference is made to FIG. 2, showing a schematic diagram of a virtual network and a system applying the tunneling technology.

The switch 20, e.g., an SDN switch, is disposed between the first server 11, the second server 12 and an OpenStack controller 22 over a virtual network. The OpenStack controller 22 implements a cloud-based operating system, in which a controller software switch 221 is performed. The OpenStack controller 22 implements a virtual network tunnel protocol by VXLAN. The switch 20 and the SDN controller 24 communicate with each other by the OpenFlow protocol for delivering the control signal and information so as to operate the Software-Defined Network. All the first server 11, the second server 12 and the OpenStack controller 22 run the software switches. The switch 20 can also run the software switch inside.

In addition to operating the first virtual machine 111, the first server 11 also runs the first software switch 113. The second server 12 runs the second virtual machine 121 and the second software switch 123. The OpenStack controller 22 runs a controller software switch 221. A virtual tunnel is established between the first software switch 113 and the second software switch 123 by VXLAN. Another virtual tunnel is established between the second software switch 123 and the controller software switch 221 by VXLAN. One further virtual tunnel is established between the controller software switch 221 and the first software switch 113 by VXLAN. The first server 11 and the second server 12 can be communicated over the virtual network via the VXLAN Tunnel Endpoints (VTEPs), i.e., the first tunnel endpoint 101 and the second tunnel endpoint 102. Furthermore, adding a third tunnel endpoint 103 of the OpenStack controller 22, the first server 11, the second server 12 and the OpenStack controller 22 can communicate via the switch 20. Similarly, the packet delivered among the OpenStack controller 22 and the virtual machines 111 and 121 is encapsulated at the third tunnel endpoint 103, and the encapsulated packet can be de-capsulated at the destination port. The above-mentioned three virtual tunnels are converged in the switch 20 and form logical links over the virtual network.

In the cloud-based virtual network implemented by an OpenStack operating system, the virtual machines can communicate with each other via the same VXLAN tunnel ID (VNI). The virtual network system can segment the subscribers according to their VNIs. The system utilizes the OpenStack controller to embody the cloud-based operating system. It is noted that the OpenStack controller operates computing, networking and storing in the cloud-based operating system. However, the method for extracting the in-tunnel flow data in the virtual network may also be implemented in a VMware or Microsoft™ virtualized platform in addition to the cloud-based operating system.

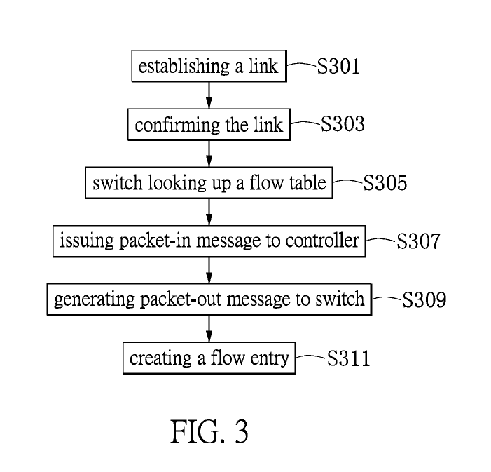

FIG. 3 shows a flow chart describing the process of forwarding packets according to one embodiment of the disclosure. In the beginning, in step S301, a connection is established between an SDN switch and an SDN controller. Each side of the connection sends an OpenFlow message with the highest OpenFlow protocol version supported by the sender to each other. The receiver calculates an OpenFlow protocol version to be used between them. After the connection has been established, both machines confirm the connection by sending Echo packets (step S303). When the packets of a flow enter the switch, the switch looks up the flow table (step S305) for finding a flow entry matching with the header of the packet.

If the flow table is empty or no flow entry is matched, the switch issues a packet-in message that carries the flow information of the packets. The switch also requests assistance from the SDN controller (step S307). When the SDN controller receives the packet-in message, the SDN controller issues a packet-out message to inform the switch to guide the packets to a specified server or host (step S309). The packets are also forwarded to a specified communication port (destination). The SDN controller simultaneously creates a new flow entry by a flow-mod message according to the information, i.e., the destination MAC address, learned from the packets (step S311). This new flow entry includes the information on how subsequent packets of this new flow should be treated in the future, so that it will not be necessary for the switch to issue the packet-in message to request the SDN controller's assistance in future instances.

In the virtual network, each server runs a software switch (OVS) and the software switch creates one or more logical ports. One or more virtual network tunnels are created between the logical ports of the software switches operated in different servers. When the original packets are delivered over the virtual network, the packets are re-encapsulated in one tunnel by a specific tunnel protocol. A new header is accordingly created. However, the in-tunnel flow of the re-encapsulated packets will not be seen or monitored by the switch in the network. The method and system for extracting in-tunnel flow data of the virtual network are therefore provided in the disclosure.

The method for extracting the in-tunnel flow data of the disclosure can be applied to the network system with a controller, and also a hybrid network system that integrates the traditional switch and the SDN switch. The method can also be adapted to a cloud-based operating system, e.g., the OpenStack OS, so as to establish a cloud-based service. The cloud-based operating system can embody a data center providing virtual hosts for multiple users. In the cloud-based operating system, the virtual network is established by means of software modules. The virtual network has multiple virtual nodes, and each node executes a networking agent. In the embodiment of the disclosure, the node operates as a server or host of a virtual machine and acts as a host or a physical switch that runs a specific switch program, e.g., a software switch. Tunnels are established between the network nodes that run the networking agents over the virtual network. The tunnels are used as logical links on the virtual network.

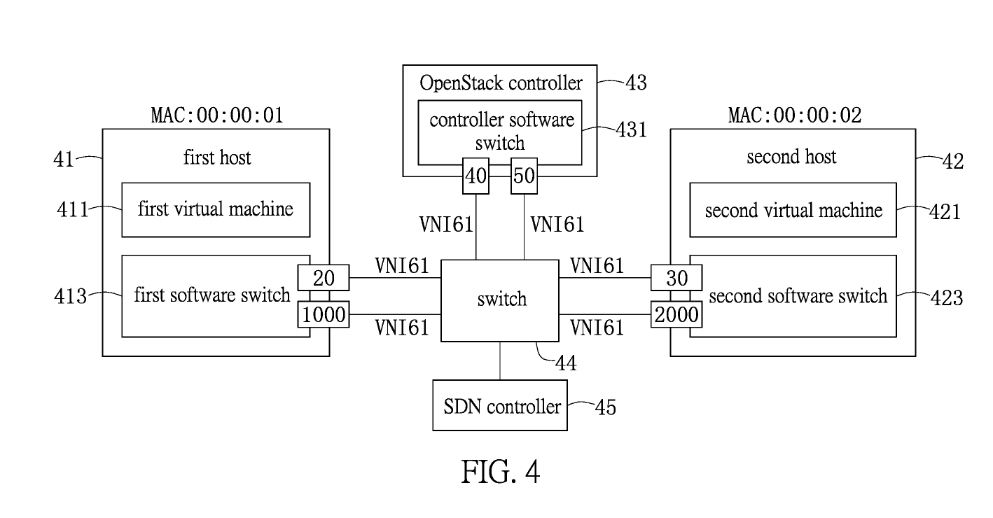

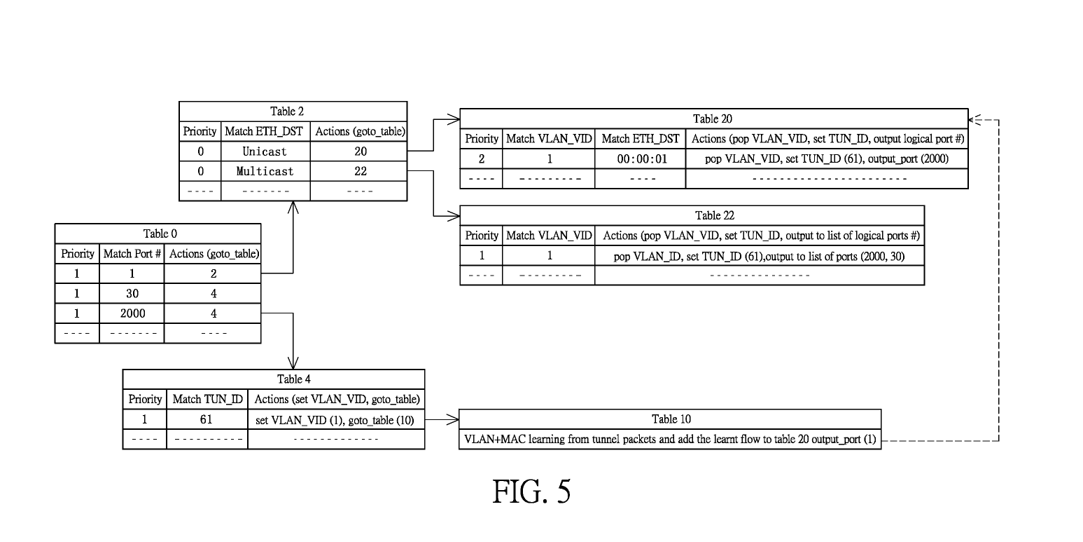

As illustrated in the following examples and as shown in FIG. 4, multiple nodes on the virtual network based on a cloud-based operating system are described. The nodes form a network system at least including a host and a switch. FIG. 5 schematically shows the flow tables in the second software switch. In FIG. 4, the first host and the second host are schematically shown in the diagram to describe messaging among the multiple hosts according to an application.

The first host 41 runs the first virtual machine (MAC:00:00:01) 411. An OpenStack controller 43 embodies a cloud-based operating system that implements a virtual network by executing the networking agents in the multiple nodes. An Open vSwitch (OVS) embodies the first software switch 413. The software switch creates the logical ports including a communication port (No. 1000) and another communication port (No. 20). One of the logical ports becomes one of the endpoints of the VXLAN tunnel with tunnel ID VNI 61.

The second host 42 runs the second virtual machine (MAC:00:00:02) 421 and the second software switch 423. The software switch creates the logical ports such as a communication port (No. 2000) and another communication port (No. 30). One of the logical ports becomes another endpoint of the VXLAN tunnel. The two tunnel endpoints define the VXLAN tunnel with tunnel ID VNI 61. All the VNI 61 tunnels go through an intermediate switch 44.

The first host 41 and the second host 42 runs the first virtual machine 411 and the second virtual machine 421, respectively, that allow a VXLAN tunnel, e.g., a virtual network tunnel with VNI 61, over the virtual network to be created. The packets delivered between the first virtual machine 411 and the second virtual machine 421 are encapsulated as the packets in compliance with a communication protocol of the virtual network tunnel at the communication port 1000 of the first software switch 413. The communication protocol over of the virtual network tunnel is such as the above-mentioned VXLAN protocol. The packet with a header recording the source and destination network addresses, MAC addresses, port numbers, type of packet and content generated by the first software switch 413 is forwarded to the communication port 2000 of the second software switch 423 via a routing mechanism of the switch 44. The packets will be de-capsulated at the No. 2000 communication port.

The virtual network tunnel is established over a physical network between the hosts (41, 42) and the switch (44) so as to form the logical link between the logical ports. The system is extremely scalable based on this architecture of the virtual network. The switch 44 is such as an SDN switch that links to the SDN controller 45 through the OpenFlow protocol. The OpenFlow protocol allows the control signals and the response signals to be delivered smoothly. The OpenStack controller 43 internally runs a controller software switch 431. A virtual network tunnel is formed between a communication port (No. 40) of the controller software switch 431 and the No. 20 communication port of the first software switch 413. Another virtual network tunnel is formed between a communication port (No. 50) of the controller software switch 431 and the communication port (No. 30) of the second software switch 423. The virtual network tunnels allow the messages generated by the OpenStack controller 43 to be smoothly delivered over the virtual network.

When the packets are delivered over the virtual network tunnel, the packets are encapsulated by a protocol adapted to this virtual network tunnel. Then, the original packets will be re-encapsulated by a tunnel protocol of the virtual network tunnel. However, this tunneling technology may not allow the switch 44 to monitor the in-tunnel flow effectively.

The operations of the logical port, the switch, and the packets delivered over the virtual network tunnel are schematically shown in FIG. 5 and describe the operation of the flow tables inside a software switch. An exemplary example of the flow tables inside the second software switch 423 is as follows.

In the present example, Table 0 of the flow tables has a plurality of flow entries and each flow entry consists of a match field and an action. The match field is the ingress port of an incoming packet and the action is “go to a specified flow table.” For example, when the packets from an internal virtual machine are matched with the flow entry indicating a No. 1 communication port, the packets will be forwarded to Table 2 according to the corresponding action. If the packets from the first host 41 are matched with a No. 2000 logical port created by a software switch, the packets are forwarded to Table 4.

The flow tables further include the table with a match field of unicast transmission or multicast transmission for distinguishing the packets. Therefore, Table 2 can be used to identify the packets as either unicast packets or multicast packets. If the packets are unicast packets, the packets will be forwarded to Table 20 according to the flow table. Similarly, Table 22 will handle the packets if the packets are multicast packets.

Further, the flow tables include the table with a virtual network tunnel ID for matching a virtual network tunnel so as to assign a VLAN ID corresponding to the virtual network tunnel ID. Table 4 is used to assign a VLAN_VID to the packet and forward the packet to Table 10 according to a virtual network tunnel ID (TUNNEL_D, VNI) carried with the packet. The virtual network tunnel ID is used to guide the packet to associate with a specific logical port in a tunnel. When the packet is received at a communication port, suppose that its VNI is 61. According to Table 4, VNI 61 indicates that the packet should be assigned with a VLAN_VID (1) and should be configured to be forwarded to Table 10. The VLAN_VID is used to identify the multiple subdomains on the virtual network. Every subdomain runs a software switch by a virtual machine.

Table 10 shows a learning event in which a VLAN ID and a MAC address are learned from the in-tunnel packet. By this learning event, a flow entry is added to Table 20, and the output port (1) is decided for this entry. The flow entry added to Table 20 includes two match fields, which are a VLAN_VID and a destination MAC address, and three actions. The three actions are such as popping VLAN_VID, setting up VNI 61 according to VLAN ID of the packet, and forwarding the packet to the No. 2000 output port.

The flow tables also include the table for releasing the VLAN ID assigned to the packets, setting up the virtual network tunnel ID and determining an output port. For example, Table 22 is used to forward the multicast packet to multiple output ports and its corresponding actions are such as popping VLAN_VID, setting up VNI 61, and forwarding the multicast packet to two ports (No. 2000 and No. 30). These output ports are the logical ports of the above-mentioned second software switch 423.

However, when the switch between the hosts fails to see the VXLAN-based or GRE-based encapsulated data flow over the virtual network, the method for extracting in-tunnel flow data is provided for the switch to obtain the information of the in-tunnel flow and monitor the in-tunnel flow. In one aspect, measures such as metering and flow bandwidth usage limit can be performed on the data of the packet when it is de-capsulated. One of the objectives of these measures is to monitor the in-tunnel flow, update its statistics and conduct bandwidth usage limit, and another objective is to distinguish the in-tunnel flows and record information relating to the usage bandwidth of data flow.

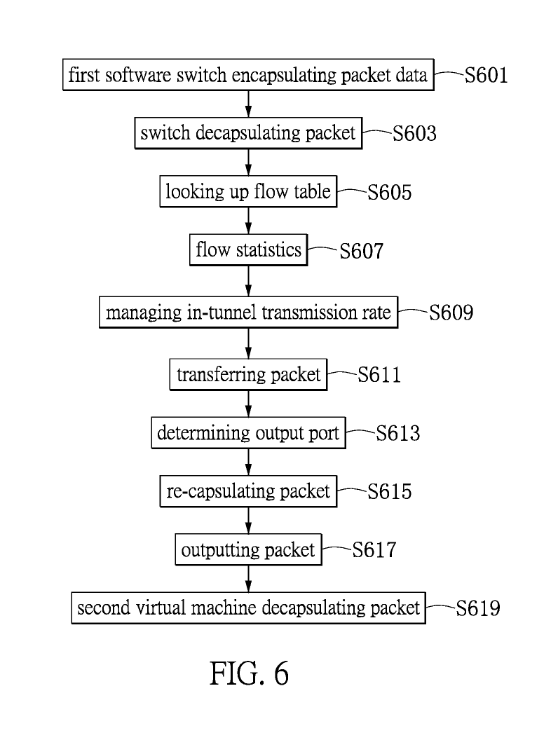

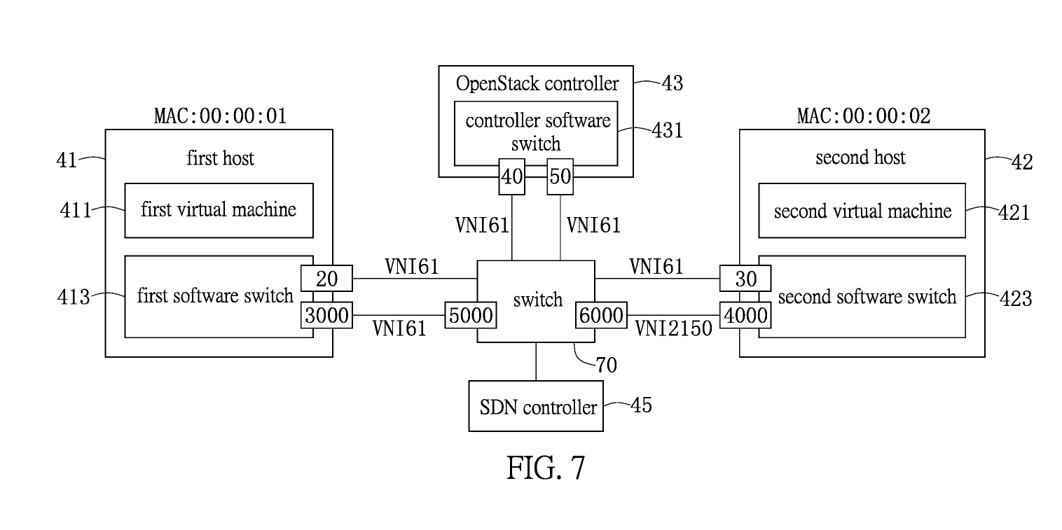

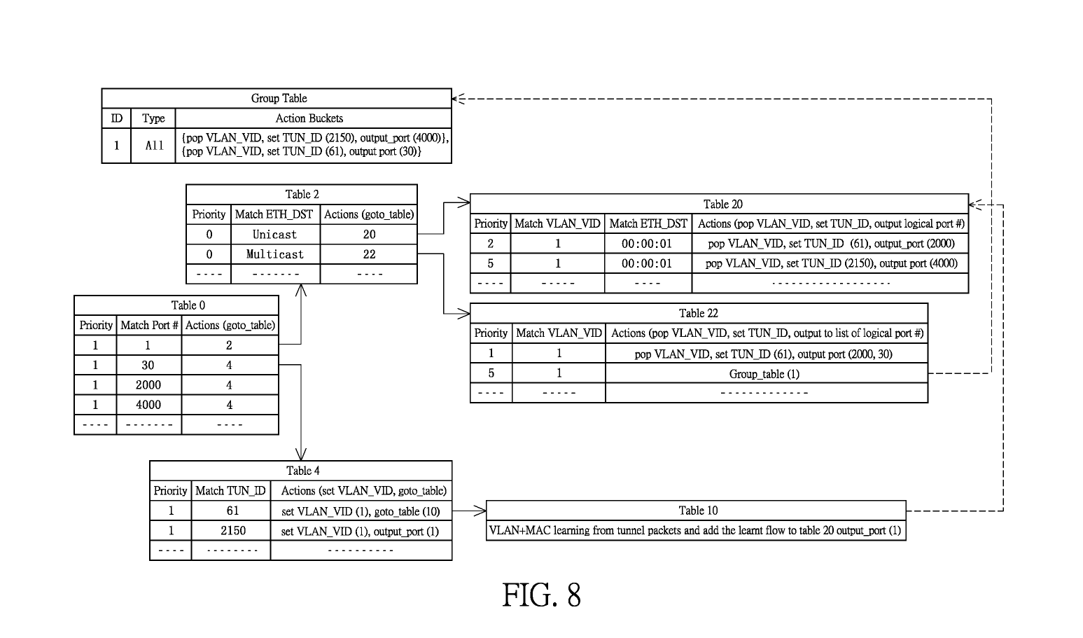

The method for extracting in-tunnel flow data over the virtual network can be achieved by modifying the flow tables operated in the software switch (OVS). The mechanism of flow tables allows the switch to obtain the usage information of the in-tunnel flow and more accurately meter the flow. Therefore, the method can be effectively applied to applications such as monitoring, metering and management of the in-tunnel flow. FIG. 6 shows a flow chart describing the method in one embodiment, and the method is applied to a network system consisting of multiple nodes schematically shown in FIG. 7. Further, reference is also made to FIG. 8 schematically describing an example of the flow tables.

In one of the embodiments, the settings of the software switches operated in the nodes on the virtual network are required to be modified for fulfilling the method for extracting the in-tunnel flow data. By the modification, two new virtual network tunnels, e.g., the VXLAN tunnels, are used to replace the original single virtual network tunnel. Therefore, the switch between the two hosts can create the endpoints on the two virtual network tunnels.

Reference is made to FIG. 7. A switch 70, a plurality of hosts 41 and 42, and controllers 43 and 45 are shown. A cloud-based operating system operated by the OpenStack controller 43 deploys a cloud service so as to constitute a virtual network. The switch 70 is such as an SDN switch that operates with the SDN controller 45. The hosts are such as the first host 41 and the second host 42 that respectively establish two virtual network tunnels labeled as VNI 61 and VNI 2150 with the switch 70. The tunnel with tunnel ID VNI 2150 replaces the original VNI 61 tunnel as shown in FIG. 4. The switch 70 runs a software switch program that is used to perform the method for extracting in-tunnel flow data over the virtual network. Two corresponding logical ports labeled as No. 5000 and No. 6000 are also created in the switch as the two VXLAN tunnel endpoints (VTEPs).

Referring to the network system shown in FIG. 7, the first virtual machine 411 of the first host 41 transmits a packet to the second virtual machine 421 of the second host 42. The packet is then encapsulated by a tunnel protocol at the No. 3000 logical port created by the first software switch 413 operated in the first host 41 (step S601). The tunnel protocol is exemplified as the VXLAN tunnel protocol. The encapsulated packet is delivered to a logical port (No. 4000) of the second software switch 423 operated in the second host 42 over the first virtual network tunnel (VNI 61) between the first software switch 413 and the switch 70, and the second virtual network tunnel (VNI 2150) between the switch 70 and the second software switch 423. The encapsulated packet is then de-capsulated at the logical port with port number 4000.

In an exemplary example, the original packet is an ICMP packet. The ICMP packet is encapsulated with information of a type of the packet, a communication protocol, a source address and a destination address of the packet, and a payload information, e.g., ETH-IP-ICMP payload. The encapsulated packet then enters a virtual network tunnel, e.g., the VXLAN tunnel. The encapsulated packet is re-encapsulated at a communication port number 3000 of the first software switch 413. The content of the original packet becomes the current payload in this encapsulation. The type, communication protocol, source and destination addresses of the packet in the header of the re-encapsulated packet are, in order, “ETH-IP-UDP-VXLAN (ETH-IP-ICMP payload).” The switch 70 then de-capsulates the packet and re-encapsulates the packet. The re-encapsulated packet is delivered to the second software switch 423 via the virtual network tunnel labeled with VNI 2150. The packet is then de-capsulated to the original form “ETH-IP-ICMP payload.”

During the time that the first virtual machine 411 transmits the packet to the second virtual machine 421, the packet is firstly encapsulated by the VXLAN tunnel protocol and enters the first virtual network tunnel (VNI 61). The switch 70 receives the packet via an input logical port (No. 5000) from the first virtual network tunnel (VNI 61), and then de-capsulates the packet by the corresponding protocol (step S603). The switch simultaneously looks up the flow table of the switch 70 (step S605).

FIG. 8 shows that the flow tables of the second software switch 423 have been updated based on the settings of the nodes of the virtual network when the method is performed. While the software switch in each node of the virtual network is being set, the flow tables should be updated (by adding or deleting) accordingly. For example, when the second software switch 423 of the second host 42 creates a logical port (No. 4000), a new virtual network tunnel (VNI 2150) with the switch 70 is established. This new virtual network tunnel (VNI 2150) is called the second virtual network tunnel. In the meantime, a fourth flow entry is added to Table 0 of the flow table shown in FIG. 8. The fourth flow entry records an entry of the No. 4000 communication port and Table 4. A second flow entry with the virtual network tunnel (VNI 2150), VLAN_VID (1) and an output communication port (No. 1) is added to Table 4. It is noted that the No. 1 communication port guides the packet to the second virtual machine 421 of the second host 42. The mentioned modification can also be applicable to the flow tables of the first software switch 413.

For an SDN switch, the software operated in the switch 70 is communicated with the SDN controller 45 through the OpenFlow protocol. The SDN controller 45 can then obtain the information of in-tunnel flows from the flow table (step S607). Statistics on the in-tunnel flows can be updated so as to manage the in-tunnel flows by metering. For example, the transmission rate of an in-tunnel flow can be limited (step S609).

The switch 70 then forwards the packet to the destination according to the header (step S611). An output port is also decided according to the flow table (step S613).

The packet is re-encapsulated at an output logical port of the switch 70. In the re-capsulation, the header of the packet is modified to add the information relating to the switch 70 and the destination host (step S615). The packet is then outputted via an output logical port (No. 6000) of the switch 70 (step S617). The packet is then transmitted to the second software switch 423 via the virtual network tunnel (VNI 2150). The packet is de-capsulated at the No. 4000 logical port (step S619) on the second software switch 423.

Reference is next made to an example of the flow tables shown in FIG. 8. The flow tables are exemplarily operated in the second software switch 423 shown in FIG. 7. Table 0 of the flow tables includes a match field that denotes a communication port where the incoming packet enters the second software switch 423. The packet matching this flow entry is forwarded to a corresponding table. For example, when the ingress port of the received packet is communication port (No. 1), which means that the packet comes from the second virtual machine 421, the packet is forwarded to Table 2. Alternatively, the packet is forwarded to Table 4 if the ingress port of the packet is the logical port (No. 4000) of the software switch running in the second host 42.

Table 2 is used to identify whether the incoming packet is for a unicast or a multicast transmission. If the packet is a unicast packet, the flow table shows that the packet will be forwarded to Table 20; otherwise, the flow table shows that the multicast packet will be forwarded to Table 22.

In Table 4, a VLAN_VID is assigned to the packet according to a tunnel ID (VNI) carried with the packet. The packet is forwarded to Table 10. When the packet is received at a communication port, Table 4 shows that the packet is assigned with VLAN_VID (1) if it is received from the VNI 61 tunnel and then the packet is forwarded to Table 10. If the tunnel ID is VNI 2150, the packet is assigned with VLAN_VID (1) and outputted via the No. 1 output port to the second virtual machine 421.

Table 10 denotes a learning entry that can learn a VLAN ID and the MAC address from the in-tunnel packet. A new flow entry is then added to Table 20 and the output port (1) is set to the packet causing it to be forwarded to the second virtual machine 421. Table 20 shows two flow entries. The first flow entry of Table 20 is a priority 2 (lower priority) entry added by the OpenStack Operating System. The second flow entry is a priority 5 (higher priority) entry added to Table 20 by the present method. Each of the flow entries includes two match fields including a VLAN_VID, a destination MAC address and three further actions. The actions are such as popping the VLAN_VID, setting VNI 61 and using the No. 2000 as the output port in the priority 2 entry, or popping VLAN_VID, setting VNI 2150 and using the No. 4000 as the output port in the priority 5 entry. In the current example, the priority 5 entry has a higher execution priority as compared to the priority 2 entry. Thus, a packet carrying VLAN_VID 1 and the destination of MAC: 00:00:01 would be matched with the priority 5 entry first, and relevant actions will be firstly executed.

Table 22 is to forward the multicast packet to multiple output ports. The related actions of Table 22 are such as popping VLAN_VID, setting VNI 61 and setting the output ports 2000 and 30. Alternatively, Table 22 can forward the packet to a group table (1). The group table (1) is with a higher priority. The group table (1) indicates two packet routes that are configured to forward the packet to a specified output port. The first packet route indicates the actions of popping VLAN_VID, setting VNI 2150 and using the port 4000 of the second software switch as the output port. The second packet route is to pop VLAN_VID, and set VNI 61 and using port 30 of the second software switch as the output port.

Based on the above-mentioned embodiments for looking up the flow tables, since the SDN controller 45 is able to obtain the flow tables from the switch 70, the aspect of the method can be applied to the system with a centralized controller. The centralized controller, e.g., the SDN controller, can acquire information such as the flow tables from all connected switches. The method can effectively acquire the in-tunnel flow data over the virtual network tunnel. Therefore, the in-tunnel flow data can be modified, monitored, and its flow entry can be deleted or added. The whole network can be effectively controlled since the flow can be under management.

In an exemplary example, the method for extracting in-tunnel flow data over the virtual network can be used in a data center. A controller of the switches, including physical and software switches, of the whole network system can administrate the data flow over the network. The management of the flow tables can be performed on every node. For example, a bandwidth management scheme can be performed for allocating different amounts of bandwidth to different subscribers, limiting an overall traffic, limiting the number of online subscribers, and managing the transmission rate and online time.

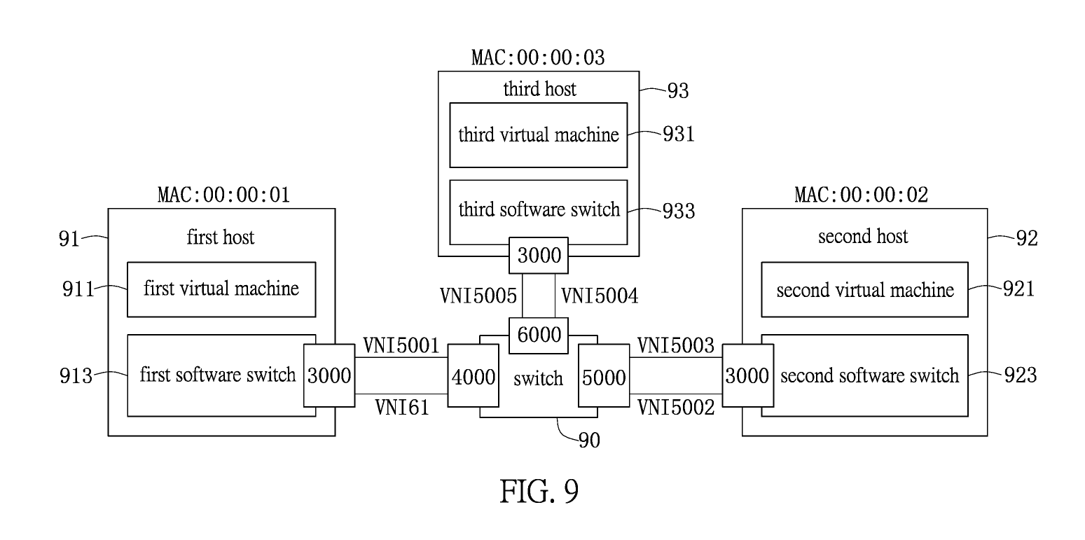

FIG. 9 shows a schematic diagram of a virtual network system in one further embodiment of the disclosure. Three hosts are schematically shown for describing the method for extracting the in-tunnel flow data over the virtual network.

A first host 91, a second host 92 and a third host 93 are connected to a switch 90. The switch 90 can also be achieved by a combination of an SDN switch and an SDN controller. The hosts 91, 92 and 93 run a first virtual machine 911 (MAC:00:00:01), a second virtual machine 921 (MAC:00:00:02) and a third virtual machine 931 (MAC:00:00:03), respectively. The hosts 91, 92 and 93 originally function on the virtual network with VXLAN tunnel ID 61 (VNI 61). For the switch 90 to be able to monitor the in-tunnel flows, the switch 90 creates six different virtual network tunnels with different tunnel IDs respectively for the first software switch 913, the second software switch 923 and the third software switch 933.

Every connection is configured to allocate a pair of virtual network tunnels assigned with different priorities from each other. In the diagram, the tunnels VNI 5001 and VNI 61 are formed between the logical port 4000 of the switch 90 and the logical port 3000 of the first software switch 913. The tunnels VNI 5002 and VNI 5003 are formed between the logical port 5000 of the switch 90 and another logical port 3000 of the second software switch 923. Further, the tunnels VNI 5004 and VNI 5005 are formed between the logical port 6000 of the switch 90 and the logical port 3000 of the third software switch 933.

In an exemplary example, the first virtual machine 911 of the first host 91 generates a packet that is configured to be transmitted to the third virtual machine 931 of the third host 93. The packet is encapsulated at the communication port 3000. The encapsulated packet is transmitted to the communication port 4000 of the switch 90 over the tunnel VNI 61. The packet is de-capsulated at this port. The header of the in-tunnel flow packet is used to look up the flow tables of the switch 90 for deciding an output port, e.g., the communication port 6000 of the switch 90. The header of the in-tunnel flow packet is also used to update the statistics of the in-tunnel flow. The header is then modified accordingly and re-encapsulated. The re-encapsulated packet is transmitted to the communication port 3000 of the third software switch 933 over the tunnel VNI 5004. The packet is again de-capsulated on the third software switch 933 for acquiring its original content. Thus, the method for extracting the in-tunnel flow data operated in the switch 90 can successfully monitor the in-tunnel flows between the first host 91 and the third host 93.

It should be noted that the method and the system for extracting the in-tunnel flow data of the disclosure can also be applied to other protocols that are in compliance with the above-described protocol.

In summation, the method for extracting in-tunnel flow data of a virtual network described in the above embodiments can be implemented by modifying the flow tables operated in a software switch (OVS). The packets can be forwarded if any flow table is matched. Otherwise, a flow entry allowing the switch to obtain the information of the in-tunnel flow added by the SDN controller or by the software switch if no flow table is matched. Therefore, the in-tunnel flow data can be monitored, metered and managed since it can be accurately metered.

It is intended that the specification and depicted embodiments be considered exemplary only, with a true scope of the invention being determined by the broad meaning of the following claims.

What is claimed is:

1. A method for extracting in-tunnel flow data within a virtual network, adapted to a switch, comprising:
receiving packets generated by a first virtual machine operated in a first host, wherein the packets are encapsulated by a tunnel protocol at a logical port created by a first software switch executed in the first host, and the encapsulated packets are transmitted to the switch via a first virtual network tunnel;
decapsulating the packets at an input logical port of the switch;
looking up a flow table according to the header of the in-tunnel packets for extracting the in-tunnel flow data;
re-encapsulating the packets by the tunnel protocol at an output logical port of the switch; and
transmitting the re-encapsulated packets to a logical port created by a second software switch of a second host via a second virtual network tunnel;
wherein, the logical port of the second software switch receives the re-encapsulated packets, the re-encapsulated packets are de-capsulated to be the original data of the packets received by a second virtual machine operated in the second host.

2. The method according to claim 1, wherein the flow tables include multiple tables, each of which has one or more match fields used for inquiring a flow entry in one of the tables that matches the header of the in-tunnel packets entering the first or second virtual network tunnel.

3. The method according to claim 1, wherein the first virtual network tunnel is configured with a tunnel ID that is different from another tunnel ID assigned to the second virtual network tunnel.

4. The method according to claim 3, wherein, while re-encapsulating the packets, the header of the packets is modified by incorporating information relating to the switch and the destination host.

5. The method according to claim 1, wherein the flow tables are updated according to a configuration of each software switch in the first host or the second host, and a new flow entry is added according to the logical port created by the second host and the second virtual network tunnel.

6. The method according to claim 5, wherein the flow tables include multiple tables, each of which has one or more match fields used for inquiring a flow entry in one of the tables that matches the header of the in-tunnel packets entering the first or second virtual network tunnel.

7. The method according to claim 1, wherein after the flow tables are looked up, the statistics of the in-tunnel flow is updated, and the in-tunnel flow is metered for bandwidth management of the in-tunnel flow.

8. The method according to claim 7, wherein a controller connected with the switch is provided for extracting in-tunnel flow data by inquiring the flow tables.

9. The method according to claim 8, wherein the switch is a software-defined network switch, the controller is a software-defined network controller, and the OpenFlow protocol is operated between the switch and the controller.

10. The method according to claim 9, wherein the flow tables include multiple tables, each of which has one or more match fields used for inquiring a flow entry in one of the tables that matches the header of the in-tunnel packets entering the first or second virtual network tunnel.

11. The method according to claim 10, wherein the flow tables further include a table with a match field of either unicast transmission or multicast transmission for distinguishing the packets.

12. The method according to claim 11, wherein the flow tables include a table with a virtual network tunnel ID for matching the virtual network tunnel so as to assign a VLAN ID corresponding to the virtual network tunnel ID.

13. The method according to claim 12, wherein the flow tables include a table for adding a flow entry of learnt a VLAN ID and a MAC address from the in-tunnel packets.

14. The method according to claim 13, where the flow tables also include a table for releasing the VLAN ID assigned to the packets, setting up the virtual network tunnel ID and determining an output port.

15. A method for extracting in-tunnel flow data within a virtual network, comprising:
a switch constituting a virtual network with a plurality of hosts at least including a first host and a second host;
wherein the first host runs a first virtual machine and executes a first software switch, and a first virtual network tunnel is established between the first host and the switch; the second host runs a second virtual machine and executes a second software switch, and a second virtual network tunnel is established between the second host and the switch;
wherein, the switch performs a method for extracting in-tunnel flow data in the virtual network comprising:
receiving packets generated by the first virtual machine, wherein the packets are encapsulated by a tunnel protocol at a logical port created by the first software switch, and the encapsulated packets are transmitted to the switch via the first virtual network tunnel;
decapsulating the packets at an input logical port of the switch;
looking up a flow table according to a header of the packets for extracting the in-tunnel flow data;
re-encapsulating the packets by the tunnel protocol at an output logical port of the switch; and
transmitting the re-encapsulated packets to a logical port created by the second software switch via the second virtual network tunnel;
wherein, when the logical port of the second software switch has received the re-encapsulated packets, the re-encapsulated packets are de-capsulated to be the original data of the packets received by a second virtual machine.

16. The system according to claim 15, wherein in the virtual network, a cloud service is implemented by a cloud-based operating system operated in an OpenStack controller.

17. The system according to claim 15, further comprising a controller coupled with the switch that looks up the flow tables to extract in-tunnel flow data.

18. The system according to claim 17, wherein the switch is a software-defined network switch, the controller is a software-defined network controller, and the OpenFlow protocol is operated between the switch and the controller.

19. The system according to claim 18, wherein in the virtual network, a cloud service is implemented by a cloud-based operating system operated in an OpenStack controller.
